(19) United States
(12) Patent Application Publication
(10) Pub. No.: US 2007/0294631 A1
(43) Pub. Date: Dec. 20, 2007

(54) Apparatus and method for embedding and utilizing report controls within an online report

(75) Inventor: James Raymond Wiseman, Vancouver (CA)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/446,335

(22) Filed: Jun. 2, 2006

(51) Int. Cl. G06F 3/048; G06F 17/00

(52) U.S. Cl. 715/764; 715/501.1; 715/513

(57) ABSTRACT

A computer implemented method includes adding a web element to a report, generating a segment of code for the web element, embedding the segment of code within the report, and publishing the report, such that in the published report the web element operates as a web element control.

### BRIEF DESCRIPTION OF THE INVENTION

This invention relates generally to an apparatus and method for creating and using report documents. More particularly, this invention relates to forming embedded web element controls within a report document, publishing the report document to support interactivity with the web element controls, and thereby provide interactivity with the report document.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and data management systems, such as relational databases or On Line Analytic Processing (OLAP) systems used to collect, store, and manage raw data.

A subset of business intelligence tools are report generation tools. There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike other non-report documents that may optionally import external data within a document, a report document by design is primarily a medium for accessing and formatting, transforming or presenting external data.

A report is specifically designed to facilitate working with external data sources. In addition to information regarding external data source connection drivers, the report may specify advanced filtering of data, information for combining data from different external data sources, information for updating join structures and relationships in report data, and logic to support a more complex internal data model (that may include additional constraints, relationships, and metadata).

In contrast to a spreadsheet, a report is generally not limited to a table structure but can support a range of structures, such as sections, cross-tables, synchronized tables, sub-reports, hybrid charts, and the like. A report is designed primarily to support imported external data, whereas a spreadsheet equally facilitates manually entered data and imported data. In both cases, a spreadsheet applies a spatial logic that is based on the table cell layout within the spreadsheet in order to interpret data and perform calculations on the data. In contrast, a report is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets generally work within a looping calculation model, whereas a report may support a range of calculation models. Although there may be an overlap in the function of a spreadsheet document and a report document, these documents express different assumptions concerning the existence of an external data source and different logical approaches to interpreting and manipulating imported data.

Reports are often published to online repositories where multiple users can interact with a published report document. This can be done using standard report viewers and dashboard type applications or custom individually programmed web applications. Report viewers, report dashboard type applications and custom applications typically support basic interactions to enable users to provide parameters and specify which data the report will display. This functionality is typically generic rather than report specific, since a generic dashboard is customizable only to a limited degree and is not specific to a given report within the system. The web application developer typically would be a different individual than the report designer. Although a programmer creating a web application could design it to have specific controls based on the report being viewed, designing generic functionality, rather than report specific functionality is typical. The programmer of the web application for displaying reports does not modify the reports themselves, but creates a framework computer program (or series of ASP or JSP webpages) for displaying and interacting with the reports.

Currently, if a user wants to specify custom controls for interacting with a published report document, either the user requires programming skills or is limited to the functionality provided by a report viewer and report dashboard application where that functionality is not report specific.

FIG. 1 illustrates a prior art work flow. A user creates 100 and publishes 102 one or more report documents. At that point either the user requires programming skills in languages such as JSP, ASP, .NET, Java, HTML, or DHTML, or the user is limited to an existing generic dashboard application that does not provide report specific interactive functionality. In the case of the user with programming skills, the user programs a web application to display the reports 104 and associates the specific reports with the web application 106. This process is not straightforward, and requires significant technical skills and effort on the part of the user. Alternatively, the user makes use of an existing reporting viewer or dashboard application to display and interact with the report documents 108. In this workflow, the user is not required to use a programming language to write a web application, but the user is limited to generic interactivity that cannot be customized to provide specific forms of interactivity for a specific report document.

In view of the foregoing, it would be desirable to provide improved techniques for adding and customizing predefined web element controls within report documents, without requiring a user to have programming skills, such that when the report is published code is generated for the web element controls and the controls provide additional interactive functionality within the published report documents.

### SUMMARY OF THE INVENTION

The invention includes a computer implemented method of adding a web element to a report, generating a segment of code for the web element, embedding the segment of code within the report, and publishing the report, such that in the published report the web element operates as a web element control.

The invention also includes a computer readable medium with executable instructions to add a web element to a report, generate a segment of code for the web element, embed the segment of code within the report, associate a property value for the web element with the embedded segment of code, and publish the report to support interactive web element control.

### BRIEF DESCRIPTION OF THE FIGURES

The invention is more fully appreciated in connection with the following detailed description taken in conjunction with the accompanying drawings, in which:

FIG. 1 illustrates a prior art workflow.

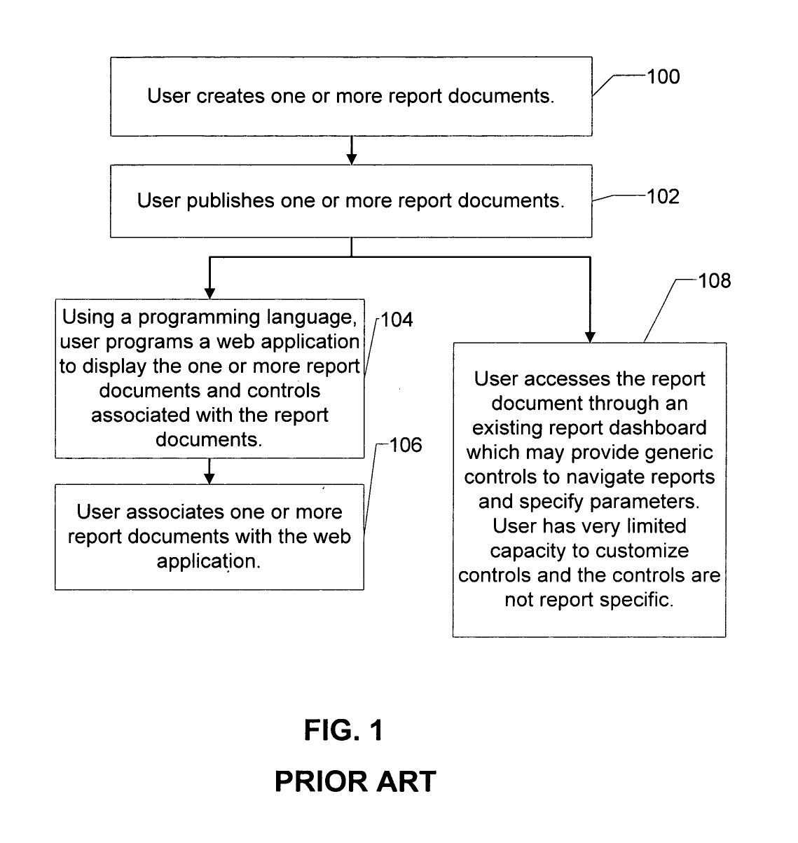

FIG. 2 illustrates a computer configured in accordance with an embodiment of the invention.

FIG. 3 illustrates a workflow for creating and publishing a report with embedded web elements, in accordance with an embodiment of the invention.

FIG. 4 illustrates a workflow for working with a published report document with web element controls, in accordance with an embodiment of the invention.

FIG. 5 illustrates a Graphical User Interface (GUI) embodiment associated with one aspect of the invention.

FIGS. 6A and 6B illustrate two alternate architectural embodiments for the invention.

FIG. 7 illustrates a workflow associated with an embodiment of the invention.

FIG. 8 illustrates a published report containing web element controls associated with an aspect of the invention.

FIG. 9 illustrates a published report containing web element controls associated with an aspect of the invention.

FIG. 10 illustrates a published report containing web element controls associated with an aspect of the invention.

FIG. 11 illustrates a published report with combined web element controls associated with an embodiment of the invention.

Like reference numerals refer to corresponding parts throughout the several views of the drawings.

### DETAILED DESCRIPTION OF THE INVENTION

The following terminology is used while disclosing embodiments of the invention:

A web element is a predefined function that can be added to a report document to enable interactive functionality in the report when it is published to a report format and location that supports interactivity. A web element can be customized by a report designer without any knowledge of programming languages.

Web element properties are used to customize a web element without any knowledge of a programming language. In one embodiment, properties for a web element are defined in a manner similar to custom report functions.

Web element controls are the generated versions of web elements that provide the logic and GUI within a published report document. Examples of web element controls include calendar tools for date selection, radio buttons, pull down menus, text boxes, buttons, and the like.

Web element control values are values specified within a web element. Web element control values can be passed to a web element through a user interaction, can be passed between web element controls, or can be passed to the web element programmatically.

Web element control context is additional information supplied with the web element control value to determine how the value should be applied.

A Programming Language is a set of symantic and syntactic rules to control the behavior of a machine. A programming language such as JSP, ASP, .NET, Java, or HTML/DHTML does not have to be written by an end user to work with web elements and to set web element properties associated with the invention.

Custom code is additional “code” that can be associated with the code that is inserted to represent a web element. Generally, this is written in a formula language (that is used in the report design) or this code could be written in a standard programming language.

Examples of web elements that have been predefined for users include core functions for building web element controls, web elements for creating target paths, web elements for creating a set of common underlying functions for building web elements, web elements for installing web elements to a repository, web elements for specifying the release version of software, and web elements for validating web element syntax. Web elements may also provide buttons and links, specifically to open additional applications, open a report in a target viewer, window, or frame, reset control values, select all control values, clear all control values, reverse control values, submit control values and other values from the report. Formatting web elements may be predefined to facilitate adding frames, images, space, text, viewers, and images. Input web elements may include calculator, calendar, check box, radio button, selection menus, cascading selection menus, text boxes, and combinations of input controls. Other web elements are available to generate outputs, such as sending emails based on control values.

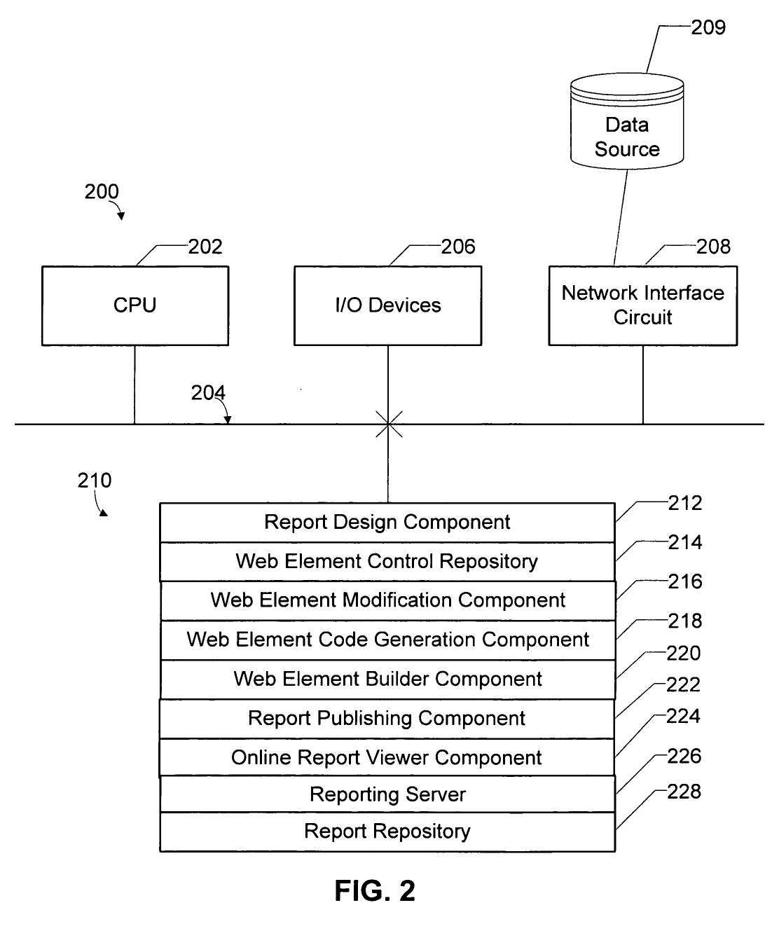

FIG. 2 illustrates a computer 200 configured in accordance with an embodiment of the invention. The computer 200 has standard components including a central processing unit 202, a bus 204, input/output devices 206, and an optional network interface circuit 208. The input/output devices 206 ma y include a keyboard, mouse, a display, and the like.

The optional network interface circuit 208 facilitates communications with networked computers (not shown) and data sources 209. The computer 200 also includes a memory 210. The memory 210 includes executable instructions to implement operations of the invention.

In the example of FIG. 2, the memory 210 includes a Report Design Component 212 to facilitate the design of report documents, a Report Publishing Component 222 to support publishing reports in various formats to local and remote locations, an online Report Viewer Component 224 to facilitate viewing published reports online, a Reporting Server 226 to facilitate the generating, refreshing, and distributing of reports, and a Report Repository 228 to facilitate the storage of report documents.

In the memory 210, a Web Element Control Repository 214 facilitates the retrieval and storage of web elements. A Web Element Modification Component 216 facilitates the modification of web element properties, adding links between web elements, and custom code to augment a web element, and the like. A Web Element Code Generation Component 218 generates code within the report document that represents the functionality and properties of the web element. A Web Element Builder Component 220 is used to interpret values passed from the web element controls within report documents published to a format and location that supports interactivity. This interpreting includes facilitating the generation of graphical representations, validating web elements, passing values between web elements, updating web elements, and using values specified by the web element control to pass values to report documents and other documents.

For simplicity, the components are shown on a single computer. Modules may be located on different computers, and report documents and web elements are designed to be distributed and viewed or used on multiple computers. It is the functions of the modules that are significant, not where they are performed or the specific manner in which they are performed.

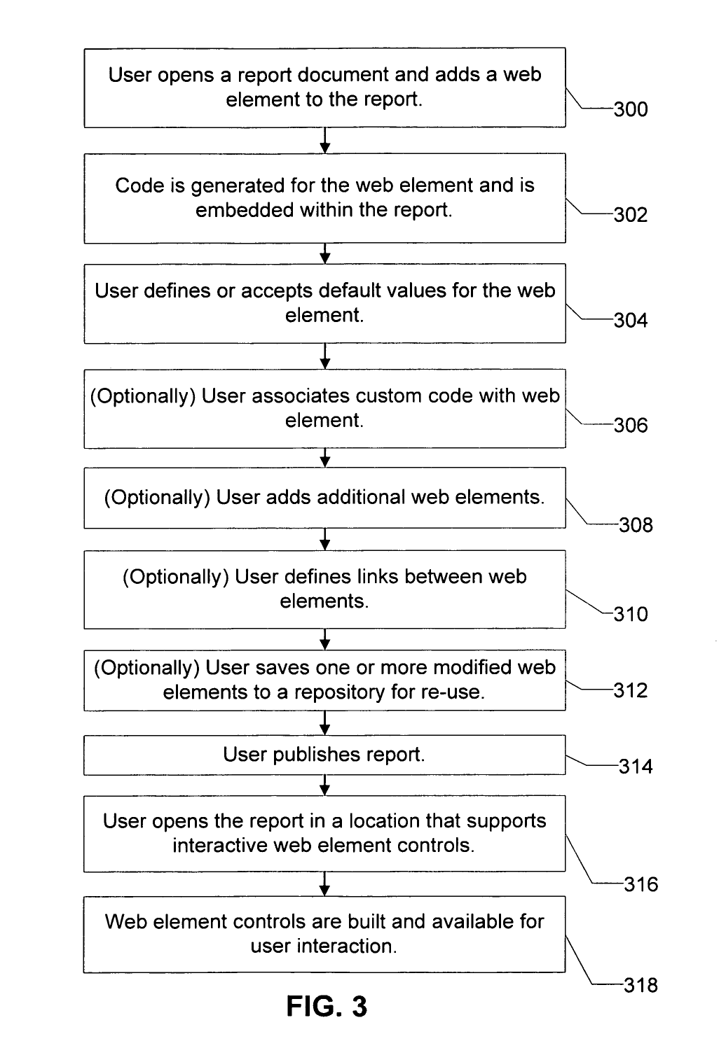

FIG. 3 illustrates a workflow associated with an embodiment of the invention. In this workflow, a user is designing a report such that the report includes web elements. A user opens a report document (either new or existing) and adds a web element to the report 300. The web element may be a core (pre-defined, standard) web element or a previously customized web element. The web element is opened from either an existing report document containing the web element or a web element control repository 214.

Code is generated for the web element and is embedded within the report 302. In one embodiment, each time a web element is inserted within the report document the associated code is automatically inserted in the report document.

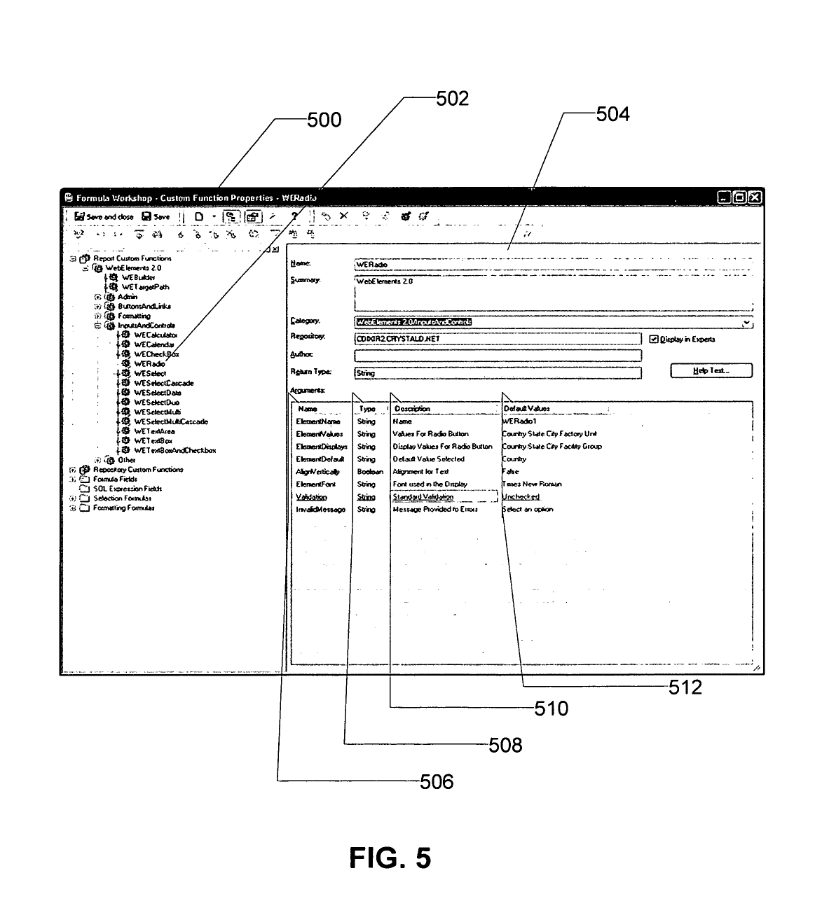

The user defines or accepts the default values for the web element 304. In one embodiment, providing values for the web elements is enabled by the GUI depicted in FIG. 5. Defining values for the web element does not require any knowledge of HTML or programming.

Optionally, the user can perform a number of tasks to further customize the web element. These tasks include: associating custom code with the web element 306, adding additional web elements 308, defining links between web elements 310, saving one or more modified web elements to a repository for re-use 312.

The user then publishes the report 314. Depending on the format to which the report is published, the interactivity of the web element controls may or may not be available. For example, the web elements may have a dependency on HTML or PDF or the like to support interactivity in the output format. A user, not necessarily the same user who published the report, opens the report in a location that supports interactive web elements 316. The web element controls are automatically built and made available for user interaction 318.

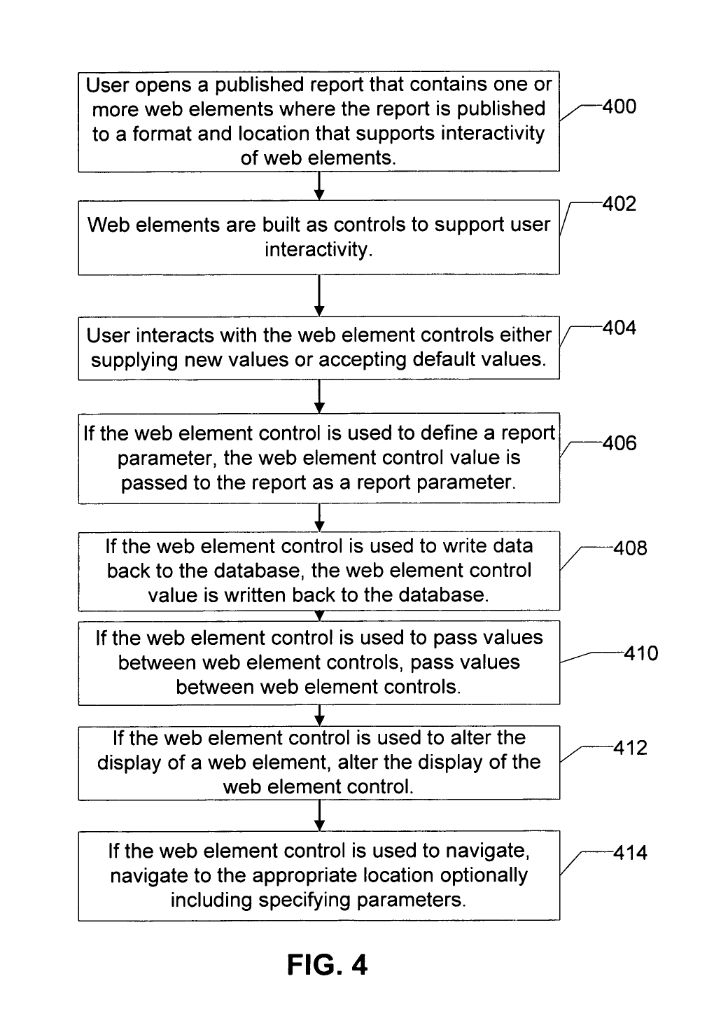

FIG. 4 illustrates a workflow associated with one embodiment of the invention. In this workflow, a user opens a published report that contains one or more web elements where the report is published to a format and location that support interactivity of web elements 400. The web elements are built as controls that support user interactivity 402.

The user interacts with the web element controls either supplying new values or accepting default values 404. Depending on the functionality that has been defined for a web element, the web element control will provide different forms of interactivity. For example, if the web element control is used to define a report parameter, the web element control value is passed to the report as a report parameter 406. If the web element control is used to write data back to the database, the web element control value is written back to the database 408. If the web element control is used to pass values between web element controls, the values are passed between web element controls 410. If the web element control is used to alter the display of a web element, the display of the web element control is altered 412. If the web element control is used to navigate, navigation to the appropriate location is completed (optionally including specified parameters) 414.

FIG. 5 illustrates a formula editing GUI 500. The web element WERadio 502 is selected for editing using an editor panel 504 where default values for name 506 and type 508 are displayed. The user can specify description 510 and default values 512. The web element WERadio defines a radio button control and the properties specified apply to the display and operation of the radio button.

This GUI enables the user to specify property values associated with the code for the web element. This GUI is an example of several alternatives (typing a formula, associating a predefined variable, etc.) provided to a user, to define the properties for the function code that is inserted to represent a radio button web element. For example the default values defined for ElementName, ElementValues, ElementDisplays, ElementDefault, AlignVertically, ElementFont, Validation and InvalidMessage are supplied to the function WERadio that is inserted when the web element is added to the report document. The following is an example of the type of function code that would be added automatically when the radio button web element was added to the report document:

Function (stringvar ElementName, stringvar ElementValues, stringvar
ElementDisplays, stringvar ElementDefault, booleanvar AlignVertically, stringvar
ElementFont, stringvar Validation, stringvar InvalidMessage);
stringvar array elementvaluesarray:= split(ElementValues,“|”);
stringvar array elementdisplaysarray:= split(ElementDisplays,“|”);
stringvar output; numbervar counter; stringvar breaker;
if AlignVertically = true then breaker:= “<BR>” else breaker:= “&nbsp&nbsp”;
if ubound(elementvaluesarray) > 1 then
while counter < ubound(elementvaluesarray) do
(
counter := counter + 1;
if elementvaluesarray[counter] < > ElementDefault
then output:= output +
‘<input type=radio name=’ + ElementName + ‘ ID=’ + ElementName + ‘\hat{ }’ +
totext(counter,0,“”) + ‘ value=“’ + elementvaluesarray[counter] + ‘”><Span ’+ ElementFont +
‘>’ + (if ElementDisplays < > “” then elementdisplaysarray[counter])+ ‘</Span>’ + breaker
else output:= output +
‘<input type=radio name=’ + ElementName + ‘ ID=’ + ElementName + ‘\hat{ }’ +
totext(counter,0,“”) + ‘ value=“’ + elementvaluesarray[counter] + ‘” checked><Span ’+
ElementFont + ‘>’ + (if ElementDisplays < > “” then elementdisplaysarray[counter])+
‘</Span>’ + breaker
);
if ubound(elementvaluesarray) = 1 then
if elementvaluesarray[1] < > ElementDefault
then
output:= output +
‘<input type=radio name=’ + ElementName + ‘ ID=’ + ElementName + ‘ value“’ +
elementvaluesarray[1] + ‘”><Span ’+ ElementFont + ‘>’ + (if ElementDisplays < > “” then
elementdisplaysarray[1])+ ‘</Span>’ + breaker
else
output:= output +
‘<input type=radio name=’ + ElementName + ‘ ID=’ + ElementName + ‘ value=“’ +
elementvaluesarray[1] +‘” checked><Span ’+ ElementFont +‘>’ + (if ElementDisplays < > “”
then elementdisplaysarray[1])+ ‘</Span>’ + breaker;
output + “<!--Radio-->” + “<!--|||-->” + WEValidator(ElementName, Validation,
InvalidMessage)

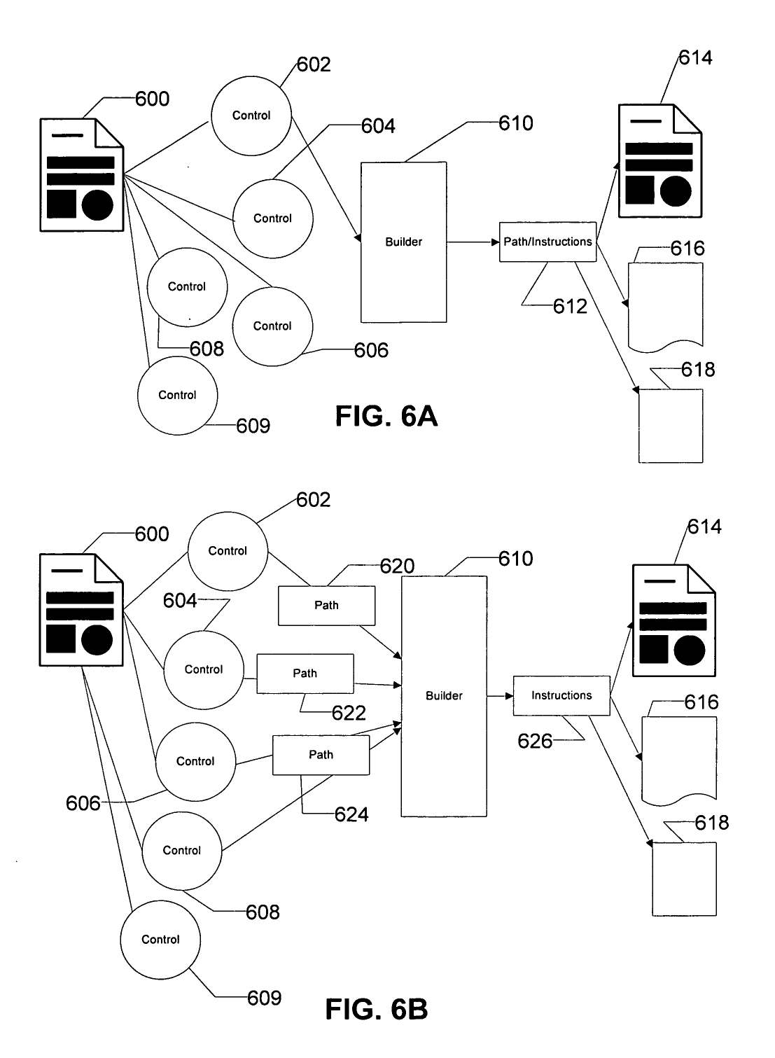

FIGS. 6A and 6B illustrate two architectural embodiments for the invention. Common to the two architectural embodiments is the basic structure wherein an online published report document 600 contains controls (602-609) generated for web elements within the report. These controls pass values to a builder 610, which then generates instructions 626 or a combination of a path and instructions 612, which are used to determine what should be displayed. This path and instruction information is used to open a report document 614 where the report document can be one of a number of report types such as an analytical report, Crystal Report™, or WebIntelligence report. Opening a report includes specifying parameters for the report, updating the query that the report is based on, and the like. Likewise, the builder can supply instructions for opening other documents 616 and secondary applications 618. In the case of opening report documents, other documents, and secondary applications, various instructions around the display of these items may also be passed from the builder 610 such that the content within the item, the window where the item will open, default login criteria, formatting, and the like are specified in the instructions.

In the architecture illustrated in FIG. 6A, only one control can pass information to the builder. Information can be passed between the controls. For example, control 602 that passes data to the builder 610 could be a submit control that passes user input from another control (604-609), which provides an input control such as a text box, combo-box, radio button, check-box or the like. In the architecture illustrated in FIG. 6A, the builder 610 constructs the path associated with the instructions and the architecture is designed to support only a single path. A path is a target location for the action based on the control. The path can be an existing or new viewer window, a frame or object element within the HTML document displayed within a viewer, or the like. In the architecture illustrated in FIG. 6A, only one of a report 614, a document 616, or an application 618 can be opened as a single path will be generated.

In the architecture illustrated in FIG. 6B, multiple paths (620-624) can be defined at the control level and one or more controls (602-609) can be associated with a given path. In FIG. 6B, controls 606 and 608 are both associated with path 624. Because in FIG. 6B multiple controls can specify different paths, more than one of a report 614, a document, or an application 618 can be opened based on the instructions generated by the builder 610.

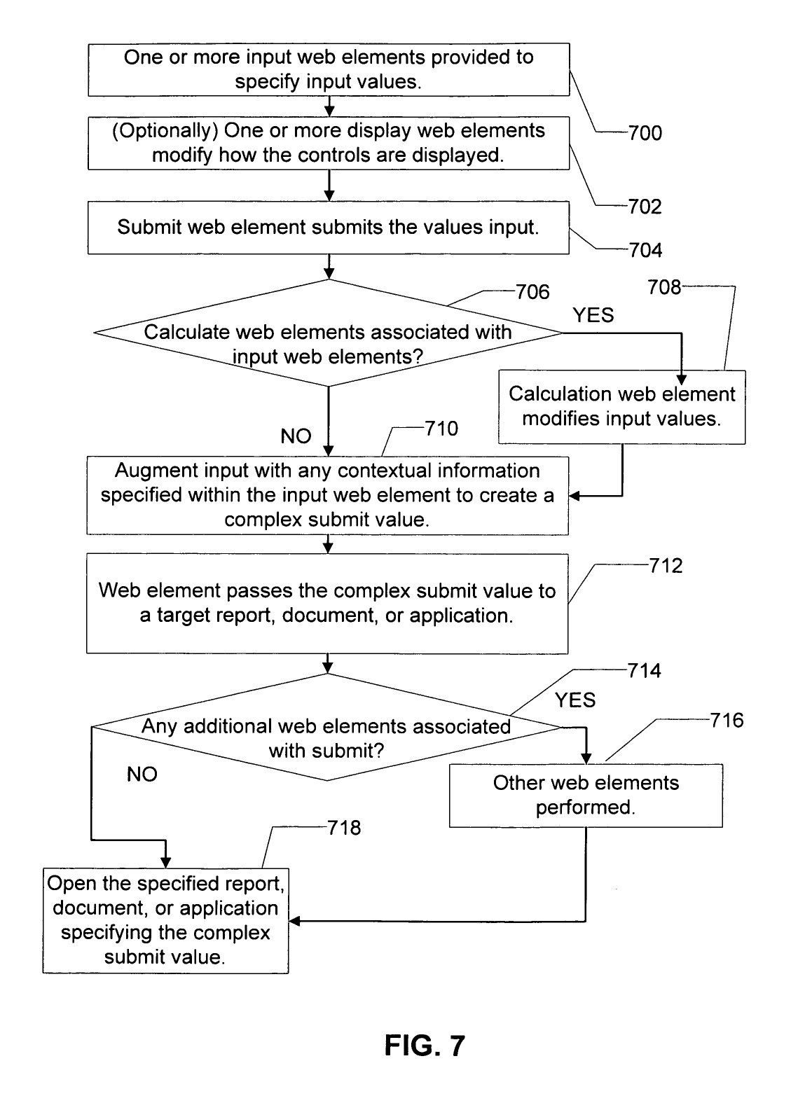

FIG. 7, for the purpose of illustration, provides a potential workflow created by associating web elements to one another when designing a report containing web elements or interacting with a published report in a format and location that supports interactivity that contains associated web element controls. One or more input web elements are provided to specify input values 700. These may include text boxes, radio buttons, check boxes, pull down menus, multiple selection menus, cascading menus, calculators, calendars and the like. One or more display web elements optionally modify how the controls are displayed 702. These include clearing values, selecting all values, modifying font size, and the like.

A submit web element submits the values that have been input in the web element controls that specify input values 704. If there are additional calculations associated with the input web elements 706 these are performed 708. These calculations could include aggregation, normalization, validation of inputs, currency adjustments, and any number of calculation formulas provided by the user designing the report. The input value is then augmented with any contextual information specified within the input web element to create a complex submit value 710. A web element passes this complex submit value to a target object (report, document, other application, and the like) 712. If there are any additional web elements associated with the submit web element 714, these will now be executed 716. These could include functionality such as emailing, alerting, modifying the controls being displayed and the like. The specified report, document, or other application is then opened with the specified complex submit value 718. The complex submit value may be used to filter and sort, write data, specify logon criteria, and the like.

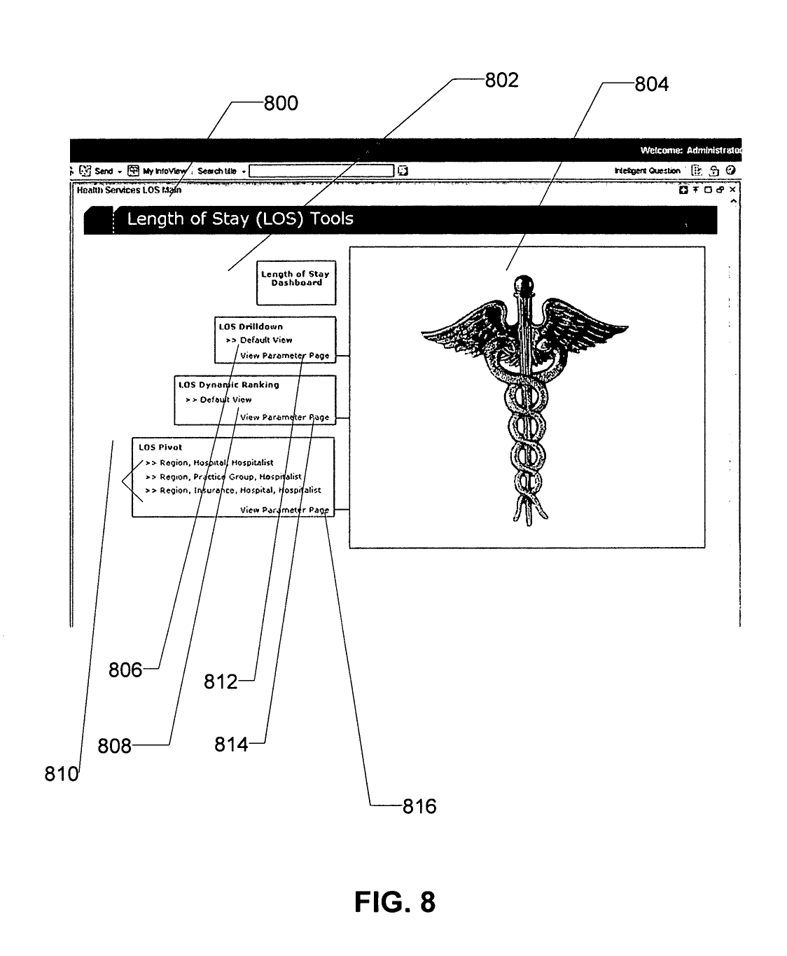

FIG. 8, for the purposes of illustration, shows an example of a published report making use of web element controls. Web elements added to report documents can be used to generate a wide number of combinations of controls and customized controls with a range of structures where controls may be on the main report, a sub-report, or another linked report. In FIG. 8, a top level report 800 makes use of multiple control paths on the same report to adjust how the report content is displayed in the portal window 804. This report includes controls and links for selecting the document to view. For example, where a specific sort order/parameter set is indicated, links 806, 808 and 810 could be executed either as simple hard coded links or could be given more dynamic flexibility as web element control links. The prompts 812, 814 and 816 trigger the display of web element controls that may combine a number of controls to dynamically submit parameter values, filters, and the sort order that will be applied.

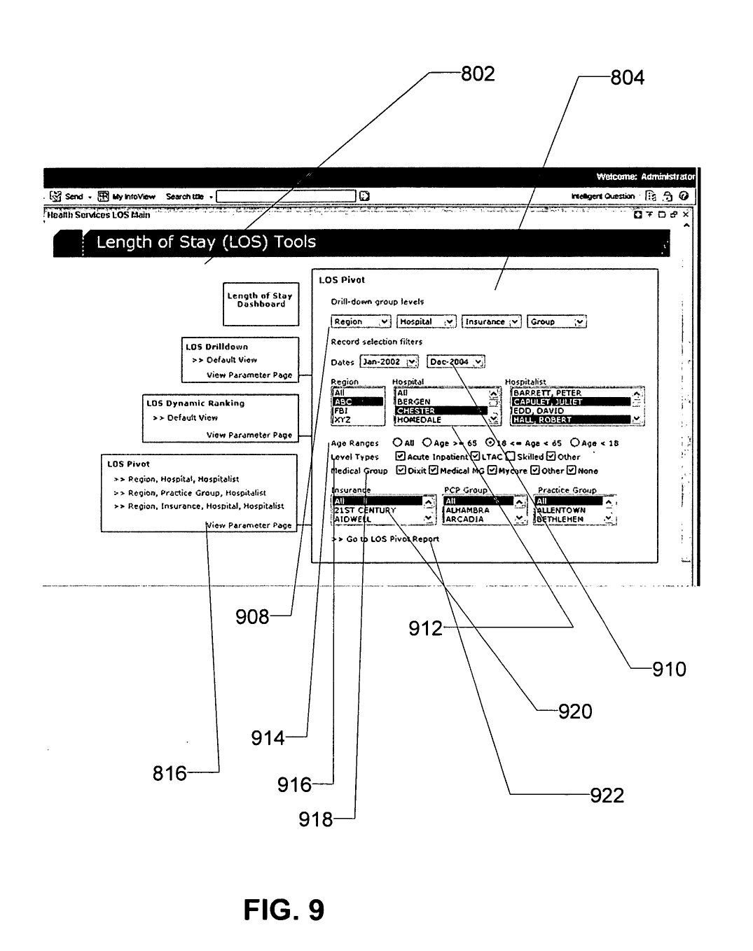

FIG. 9 illustrates the same published report as FIG. 8 and the collection of web element controls that are displayed in response to clicking 816 to “View the Parameter Page” for the LOS Pivot report. In the right hand panel 804, the generic graphic is replaced with a set of web element controls where a user can set a number of values to determine the content displayed in the returned document. Controls for value input include pull down menus 908, 910, cascading multiple selection dropdown menus 912, 920, radio buttons 914, check-boxes 916, 918, and a submit link 922. This set of input web element controls is illustrative and by no means comprehensive; a number of other input web element controls that are not included in this group of controls are available in the standard web element repository library.

The user can select values for the controls (908-920), and then the submit control 922 combines the values and sends the values to the web element builder component 220. The builder generates the appropriate instructions and displays the resulting document that matches the specified criteria.

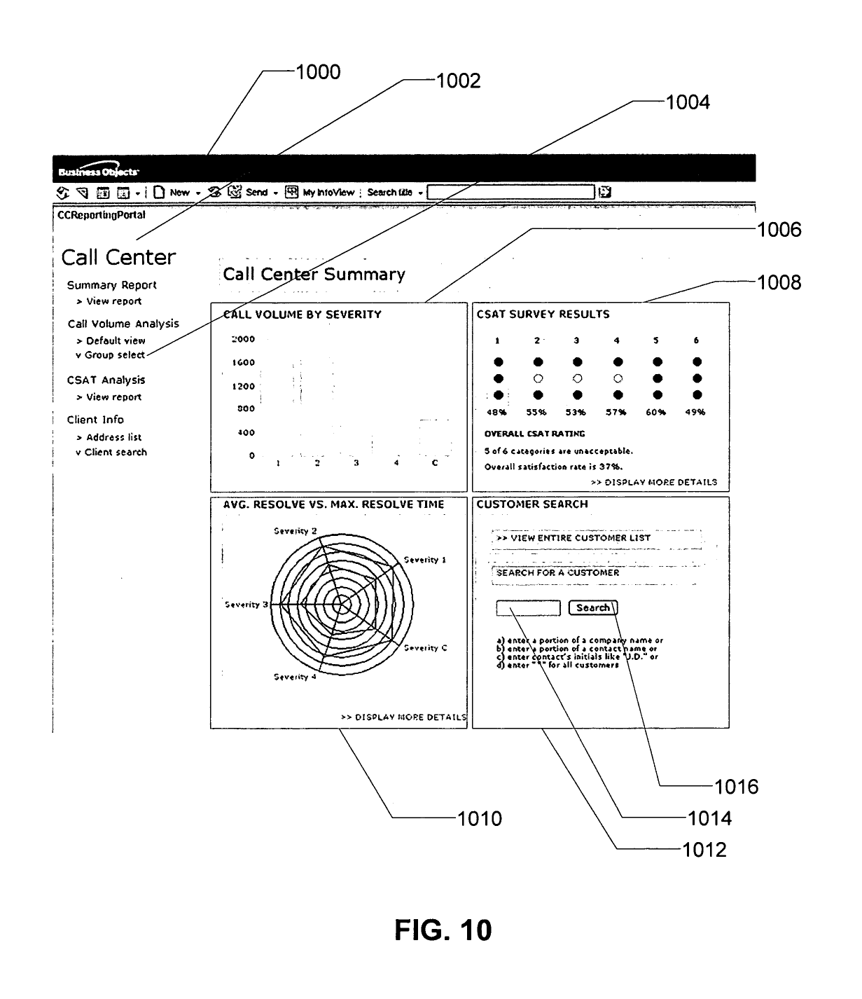

FIG. 10 illustrates an example of a published report that contains web element controls as well as using frames to display other reports that contain web element controls. Within the viewer 1000, first report 1002 is displayed and contains frames 1006, 1008, 1010, 1012 in which additional published report/document content can be displayed. The first report can contain web elements designed to interoperate with the other reports. For example, this first report contains web element controls, such as Group select 1004, which displays a set of controls for selecting the groups shown in a call volume analysis report displayed in frame 1006. Additionally, the reports within the frames can also contain web elements such as the interactive search functionality shown in frame 1012. This search control uses a text box web element control 1014 combined with a submit button control labeled Search 1016 to receive an input value, pass that value to a second customer list report as a query parameter, and return the values that match the search term. This second published customer list report may in turn include web element controls that facilitate selecting customers to display in the second customer list report, grouping based on customer, or the like in the second published customer list report or in yet a different report. These reports can all be navigated and displayed within the context of the first report 1002 and the same frame 1012 or other frames within the first report.

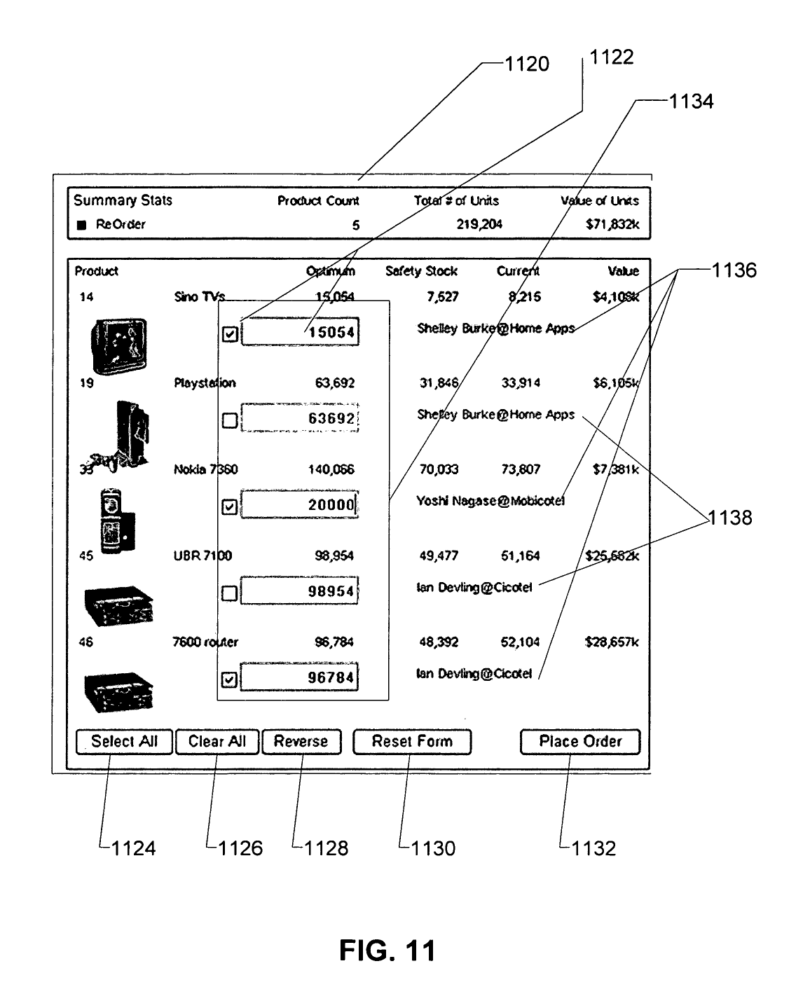

FIG. 11 illustrates an example of a first published report 1120 that contains a combined web element control 1122 to facilitate the write back of data to a data source. In this example, a combined control to select items and modify a populated field for the number of units to reorder 1122 enables a user to select whether to order an item (using a check box) and then specify the number of units to order (using a text box). When the user clicks the submit button labeled Place Order 1132, the combined input control then analyzes all of the input control values for this type of input 1134, takes the values where the check box has been selected, and passes, these values along with their data context to a second report that contains function code to write the input parameters to the data source. Additional controls 1124, 1126, 1128, 1130, are provided to enhance the interactivity of the first published report. In addition to the visible controls, other controls are associated with the report such that when an order is submitted the contact associated with the product is automatically sent an email or other form of alert. In this case, a first group of contacts 1136 is emailed or alerted for products purchased, and a second group 1138 is not alerted when products are not selected for re-ordering. The logic for this emailing and alerting is customizable within the web element in this exemplary embodiment.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C#, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising:
adding a web element to a report;
generating a segment of code for the web element;
embedding the segment of code within the report; and
publishing the report, wherein in the published report the web element operates as a web element control.

2. The method of claim 1 wherein adding includes adding the web element to a report in a first graphical user interface, where the method further comprises opening the report within a second graphical user interface.

3. The method of claim 1 further comprising facilitating navigation of the report with the web element control.

4. The method of claim 1 further comprising specifying a parameter to the web element control to interact with the report.

5. The method of claim 1 further comprising writing data back to a data source in response to the web element control.

6. The method of claim 1 further comprising:
selecting a web element with at least one property set to a default value; and
displaying a parameter associated with the web element, wherein the parameter is selected from a: name, type, description, and value.

7. A computer readable medium including executable instructions, comprising executable instructions to:
add a web element to a report;
generate a segment of code for the web element;
embed the segment of code within the report;
associate a property value for the web element with the embedded segment of code; and
publish the report to support interactive web element control.

8. The computer readable medium of claim 7 further comprising executable instructions to:
present to a first user a control value for the web element control; and
accept selection of the control value.

9. The computer readable medium of claim 7 further comprising executable instructions to:
open the report within a second graphical user interface associated with a second user; and
build the web element control within the second graphical user interface.

10. The computer readable medium of claim 7 further comprising executable instructions to associate custom code with the web element control.

11. The computer readable medium of claim 7 further comprising executable instructions to define a link between the web element control and another web element control.

12. The computer readable medium of claim 7 further comprising executable instructions to save the web element control to a repository of web element controls.

13. The computer readable medium of claim 7 wherein the segment of code within the report supports user interactivity.

14. The computer readable medium of claim 7 wherein the web element control passes web element control values to the report as a report parameter.
